(19) United States
(12) Patent Application Publication
(10) Pub. No.: US 2026/0226773 A1
(43) Pub. Date: Aug. 6, 2026

(54) MOTOR VEHICLE LOCK, IN PARTICULAR MOTOR VEHICLE DOOR LOCK

(71) Applicant: Kiekert Aktiengesellschaft, Heiligenhaus (DE)

(72) Inventors: Ömer INAN, Dorsten (DE); Peter SZEGENY, Engelskirchen (DE); Michael SCHOLZ, Essen (DE); Holger SCHIFFER, Meerbusch (DE); Thorsten BENDEL, Oberhausen (DE)

(73) Assignee: Kiekert Aktiengesellschaft, Heiligenhaus (DE)

(21) Appl. No.: 19/153,995

(22) PCT Filed: Jan. 5, 2024
(86) PCT No.: PCT/DE2024/100008

§ 371 Date: Aug. 15, 2025

(30) Foreign Application Priority Data
Feb. 7, 2023 (DE) 10 2023 102 858.8

(51) Int. Cl. E05B 81/90; E05B 81/06; E05B 81/14; E05B 81/30; E05B 81/42; E05B 81/64

(52) U.S. Cl. CPC E05B 81/90; E05B 81/06; E05B 81/14; E05B 81/30; E05B 81/42; E05B 81/64

(57) ABSTRACT

A motor vehicle lock, in particular a motor vehicle door lock, is equipped with a locking mechanism substantially consisting of a rotary latch and a pawl. Furthermore, an electromotive drive for the locking mechanism is provided. An emergency actuation element is additionally provided for manually opening the locking mechanism, for example in the event of a failure of the electromotive drive. According to the invention, the electromotive drive has a deflecting contour for unlocking the emergency actuation element.

The invention relates to a motor vehicle lock, in particular a motor vehicle door lock, with a locking mechanism substantially consisting of a rotary latch and a pawl, further with an electromotive drive for the locking mechanism, and with an emergency actuation element for manually opening the locking mechanism, for example in the event of a failure of the electromotive drive.

Motor vehicle locks, and in particular motor vehicle door locks, are increasingly equipped with an electromotive drive for the locking mechanism for reasons of convenience and improved acoustics. In this case, for example, a control unit ensures that after a sensor signal is registered, the electromotive drive is actuated in order to lift the pawl from its engagement with the rotary latch. As a result, the rotary latch opens in a spring-assisted manner and releases a previously caught locking bolt and thus also the associated motor vehicle door.

The sensor signal for starting the described electrical opening process may originate, for example, from a switch on an outside door handle. However, it is also possible that following a question/answer dialog between a user-side card or a transponder and the motor vehicle and a positive access check, the motor vehicle lock in question is subsequently opened in an electromotive manner. Such an electromotive opening process is therefore associated with only minimal or even no operating force, and is therefore favored in practice. In addition, the electric opening process is particularly quiet.

However, the proper functioning of the electromotive drive for the locking mechanism requires that sufficient voltage and general electrical energy in general be available from an on-board battery of the associated motor vehicle. In practice, problems may arise in this regard if the battery in question is discharged or, for example, damaged as a result of an accident to such an extent that the required vehicle electrical system voltage is no longer available. There are also so-called electric backup solutions for such electric locks that use their own additional energy source for emergency operation.

However, even with such emergency energy sources, there is the general problem that they may be or become defective, lose their electrical energy, or may not have been charged during operation, etc. In this case, an emergency actuation element is typically provided for manually opening the locking mechanism, for example, in the event of a failure of the electromotive drive.

In fact, the generic prior art according to DE 10 2018 104 421 A1 proposes an emergency actuation element which is mechanically coupled to the associated motor vehicle door lock via a connecting means. In addition, an actuator is provided that mechanically interacts with the connecting means, which blocks the connecting means during normal operation, and releases it during emergency operation. The actuator can be moved by an electric motor. In this respect, the electromotive drive implemented at this point is only indirectly intended and implemented for the locking mechanism.

The further prior art according to DE 10 2015 122 121 A1 deals with a method for manually actuating a motor vehicle door and, in particular, for emergency opening. In this context, the vehicle speed is evaluated and at least one speed threshold is defined using a control device. Depending on the actuation of a door handle, the control unit is queried and controls a functional unit to unlock/open the vehicle door depending on the speed.

Finally, the prior art to be considered according to DE 10 2019 126 596 A1 relates to a motor vehicle lock which is equipped with an electromotive drive for the locking mechanism. In addition, the electromotive drive can actuate a safety lever to assume its unlocked position. A stop is provided for the electromotive drive, which limits the movement of the electromotive drive at least when it is actuated in the opening direction to cancel the unlocked position. This prevents the locking mechanism from opening.

The prior art has generally proven effective when it comes to implementing emergency measures following, for example, a failure of the electromotive drive to open the locking mechanism. However, the prior art can be improved in that the proper action upon the emergency actuation element or its activation/deactivation has not always been reliably achieved. In practice, the typical procedure is for the motor vehicle lock in question to generally assume its locked position. This also applies to the emergency actuation element. Only in the event of failure of the electromotive drive should the emergency actuation element be transferred to its unlocked state for manual opening of the locking mechanism. This has not yet been achieved, or at least not with the necessary functional reliability. The invention as a whole seeks to remedy this.

The invention is based on the technical problem of further developing such a motor vehicle lock, and in particular a motor vehicle door lock, in such a way that the emergency actuation element can be selectively activated in the event of a failure of the electromotive drive.

In order to solve this technical problem, a generic motor vehicle lock and, in particular, a motor vehicle door lock according to the invention is characterized in that the electromotive drive has a deflecting contour for unlocking the emergency actuation element.

First of all, the invention is based on the realization that the electromotive drive can be used for more than just the electrical opening of the locking mechanism. Instead, by means of the electromotive drive, a second functionality can be provided during emergency operation, ensuring that the emergency actuation element is unlocked via the deflecting contour. This means that the emergency actuation element—like the rest of the motor vehicle lock—is typically and in the normal state in its functional position “locked”. This means that any action upon an outside door handle or an inside door handle, or both, generally has no effect on the corresponding motor vehicle door, which is expressly desired and in many countries is even mandatory while the motor vehicle is in motion.

Only when emergency operation or emergency actuation has to be initiated, for example, because the electromotive drive is about to fail or the power supply can no longer be guaranteed, does the electromotive drive ensure that the emergency actuation element is unlocked via its deflecting contour. By unlocking the emergency actuation element, an operator can then easily open the locking mechanism mechanically and manually via the emergency actuation element or an emergency actuation lever chain implemented at this point and consequently also unlocked. For this purpose, the electromotive drive works on a coupling lever via the deflecting contour and transfers it from its “disengaged” position assumed during normal operation to the “engaged” position.

In the disengaged position of the coupling element, the emergency actuation lever chain already mentioned is mechanically interrupted by the emergency actuation element. In contrast, the “engaged” position of the coupling element corresponds to the emergency actuation lever chain being mechanically closed. The invention achieves this by using the deflecting contour to transfer the coupling element from its routinely assumed disengaged position to the engaged position.

This means that the motor vehicle lock is always mechanically locked during normal operation. In order to realize and implement the unlocking of the emergency actuation element, the electromotive drive must be controlled in such a way that a kind of “parking position” is reached. This happens in such a way that, in this parking position, the deflecting contour transfers the coupling element, as a component of the emergency actuation lever chain, from its disengaged position to its engaged position. This typically happens when the electromotive drive fails or is about to fail. This may happen in the event of a crash or if the battery voltage of a vehicle battery falls below a certain threshold value. The same may apply to an emergency power source.

In any case, the invention operates in such a way that if the vehicle electrical system voltage or the voltage of the emergency power source drops, the electromotive drive is actuated at least to the extent that it assumes its previously mentioned “parking position”. This corresponds to the fact that the electromotive drive with its deflecting contour acts on the coupling element as a component of the emergency actuation lever chain, so that the coupling element is transferred from its previously assumed disengaged position into the engaged position. The emergency actuation lever chain is now closed or unlocked, and a manual actuation of the emergency actuation element allows the locking mechanism to be opened mechanically and manually. As long as the electromotive drive remains in the “parking position” described above, the mechanical emergency actuation is active and the coupling element is unlocked so that the corresponding motor vehicle door can be opened from the inside, for example, using an interior door handle. Of course, it can also be opened from the outside.

In order for the electromotive drive to be able to approach the “parking position” in question with precision, according to a further advantageous embodiment, the procedure is such that by way of example the deflecting contour for the coupling element sweeps over a defined range of an actuating path of the electromotive drive. This means that the actuating path of the electric motor drive corresponds at least to the fact that with its help the locking mechanism can be opened by lifting the pawl from its engagement with the rotary latch. In addition, the actuating path also comprises the defined range in question, in which the deflecting contour ensures that the emergency actuating element is active, or that the coupling element is unlocked, and consequently that the emergency actuation lever chain is mechanically closed.

In order to ensure that this defined range can be reached precisely as part of the actuating path of the electromotive drive, an evaluation of an electrical actuation signal from the electromotive drive and/or an evaluation of signals from a sensor is performed. In the first case, the electrical actuation signal of the electromotive drive is examined with regard to a possible current increase when the deflecting contour is reached.

The invention is based on the knowledge that approaching the previously mentioned “parking position” is accompanied by an increased mechanical resistance. This is because approaching the “parking position” requires the deflecting contour to transfer the coupling element from its previously and routinely disengaged position into the engaged position. This involves a certain amount of force, which manifests itself in an increase in the current of the electrical actuation signal of the electromotive drive. This current increase can be evaluated by a control unit controlling the electromotive drive in such a way that the current increase is used to identify when the deflecting contour has been reached. After detecting the current increase, the electromotive drive is usually switched off. This is because the electromotive drive has now reached the “parking position” mentioned above.

Alternatively or additionally, it may also be possible to work with a drive pulley of the electromotive drive and/or a sensor assigned to the electric motor. In this case, the position of the drive pulley may be detected by the sensor to determine whether the “park position” discussed above has been reached or not. However, a sensor assigned to the electric motor can also be evaluated in the same or an additional manner. This may be a rotation angle sensor.

The invention is based on the knowledge that a certain angle of rotation of the electric motor corresponds to a certain actuating path of the drive pulley, from which it can then be concluded whether or not the coupling element has been reached by the deflecting contour of the electromotive drive. In all these cases, the sensor reliably indicates whether or not the electromotive drive has reached the “parking position.” Of course, the sensor signal can also be combined with the evaluated current increase when the deflecting contour is reached. This allows the accuracy of reaching the “parking position” to be increased even further.

The drive pulley usually has more than one contour for controlling the sensor in question. However, in most cases, the drive pulley is also equipped with an actuating cam for the pawl. As a result, the drive pulley—and thus the electromotive drive as a whole—fulfills its dual functionality within the scope of the invention, namely, on the one hand, to lift the pawl from its engagement with the rotary latch for electromotive opening, and, on the other hand, to enable switching to emergency opening operation by means of the electromotive drive.

The sensor or sensors mentioned above can operate in different ways. It is therefore conceivable that the sensor functions in a tactile or contactless manner. Consequently, the sensor may be a switch, a Hall sensor, or a combination thereof. An optical sensor is also possible.

As a result, a motor vehicle lock, and in particular a motor vehicle door lock, is provided which consistently assumes its locked position during normal operation, and is only transferred to the unlocked position of an emergency actuation lever chain during emergency operation. This is ensured by the electromotive drive, which, according to the invention, has a dual function. This is because, by means of the electromotive drive, the locking mechanism can typically be actuated for electrical opening in one direction of rotation, whereas in the other direction of rotation, or even in the same direction of rotation, the emergency actuation lever chain in question can be unlocked for manual and mechanical emergency opening of the locking mechanism. For this purpose, the electromotive drive is equipped with a deflecting contour, usually for a coupling element. The deflecting contour is used to transfer the coupling element from its previously disengaged position to the engaged position.

In this way, the associated emergency actuation lever chain changes from its open to a closed mechanical state, so that the locking mechanism can be opened mechanically via the emergency actuation element as an alternative to the electric opening in emergency operation. All of this is achieved in a particularly simple and functionally reliable manner, and only requires an electromotive drive. This keeps both the cost and the design effort low. These are the main advantages.

The invention is explained in greater detail below with reference to drawings which show only one exemplary embodiment. In the drawings:

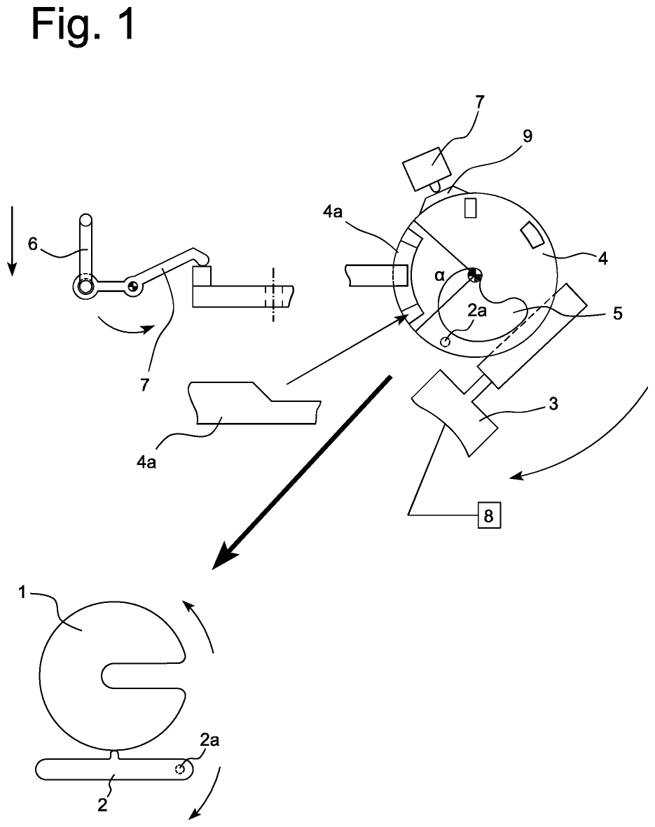

FIG. 1 schematically shows the motor vehicle lock according to the invention, in a first embodiment,

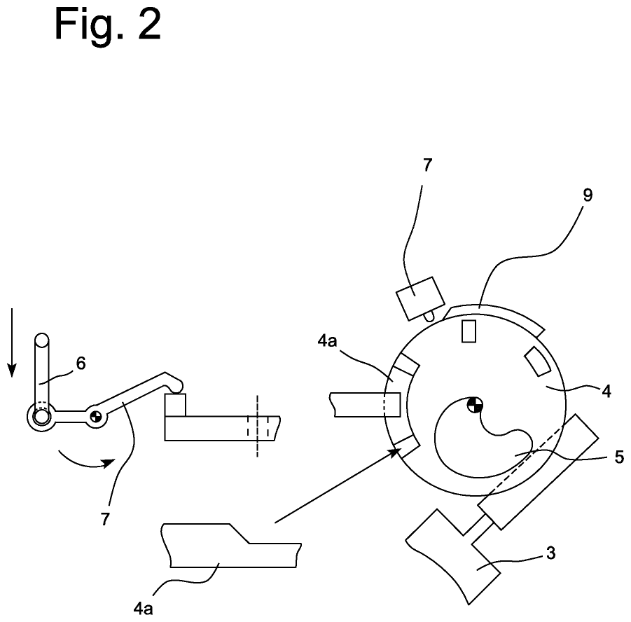

FIG. 2 shows a variant of the subject matter shown in FIG. 1,

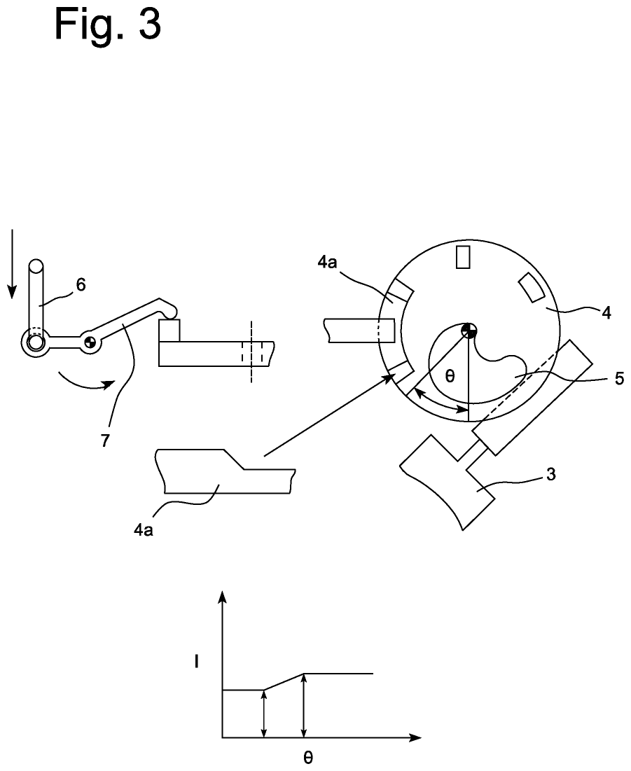

FIG. 3 shows a further third embodiment of the invention, and

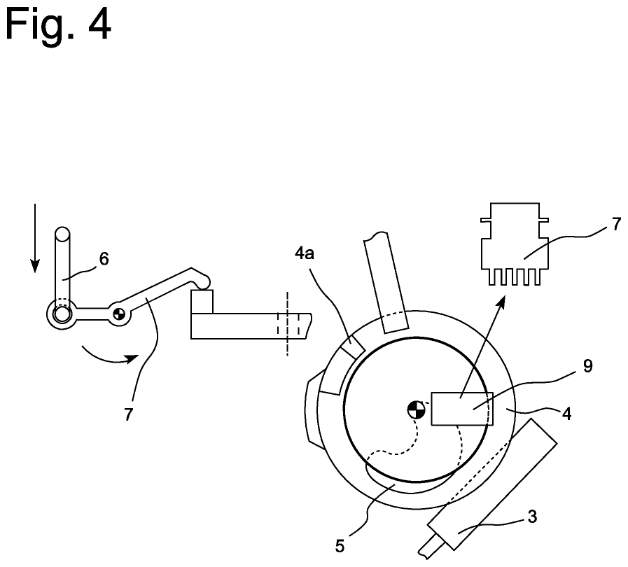

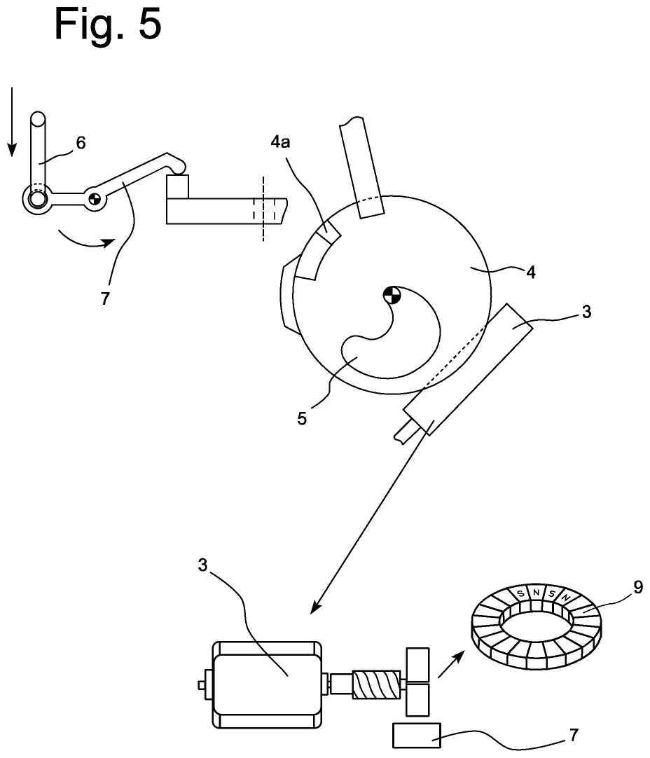

FIGS. 4 and 5 show further possible embodiments of the invention.

In the figures, a motor vehicle lock and in particular a motor vehicle door lock is shown. In its basic design, it has a locking mechanism 1, 2 substantially consisting of a rotary latch 1 and a pawl 2, both of which are depicted and shown by way of indication in FIG. 1. In the functional position shown in FIG. 1, the locking mechanism 1, 2 is in its closed state. In order to open the locking mechanism 1, 2, an electromotive drive 3, 4, 5 is provided for the locking mechanism 1, 2.

According to the exemplary embodiment, and not by way of limitation, the electromotive drive 3, 4, 5 consists of an electric motor 3, a drive pulley 4 meshing with the electric motor 3, and an actuating cam 5 on the drive pulley 4. Clockwise rotational movements of the drive pulley 4 about the associated axis of the drive pulley 4 result in the actuating cam 5, which according to the exemplary embodiment is located on the underside of the drive pulley 4, acting on a pin 2a as a component of the pawl 2, so that the pawl 2 pivots about its axis in the clockwise direction indicated in FIG. 1. This releases the rotary latch 1 from the pawl 2 and allows it to swing open in a spring-assisted counter-clockwise direction, also indicated in FIG. 1, and release an associated locking bolt. As a result, a motor vehicle door equipped with the locking bolt can be opened.

The further basic structure also includes an emergency actuation element 6, 7, which is a component of a manually actuated and purely mechanically acting emergency actuation lever chain 6, 7. The emergency actuation element 6, 7 therefore allows manual opening of the locking mechanism 1 2, regardless of the electrical opening process described above.

According to the exemplary embodiment, the electromotive drive 3, 4, 5 has a deflecting contour 4a for the emergency actuation element 6, 7 or for unlocking the emergency actuation element 6, 7. For this purpose, the emergency actuation element 6, 7 according to the exemplary embodiment consists, on the one hand, of a coupling element 6, and, on the other hand, a transmission lever 7.

The transmission lever 7 interacts with the deflecting contour 4a. In addition, according to the exemplary embodiment, the transmission lever 7 ensures that the coupling element 6 moves into its “engaged” position indicated in FIG. 1 when the transmission lever 7 is acted upon by means of the deflecting contour 4a.

The “engaged” position of the coupling element 6 indicated in FIG. 1 corresponds to the emergency actuation lever chain 6, 7 being mechanically closed. Acting upon the emergency actuation lever chain 6, 7 in question, for example, by a handle provided at the end (such as an interior door handle), causes the pin 2a of the pawl 2 to be acted upon again via this emergency actuation lever chain 6, 7, or to be acted upon in such a way that the pawl 2—this time manually and mechanically—is lifted from its engagement with the rotary latch 1, so that as a result the locking mechanism 1, 2 opens and releases the locking bolt referred to above. This is possible in particular if there is a failure of the electromotive drive 3, 4, 5 for the reasons already described above.

According to the exemplary embodiment, the deflecting contour 4a is realized and provided on the drive pulley 4 as a component of the electromotive drive 3, 4, 5. In addition, the deflecting contour 4a sweeps over a defined range (angle α) of an actuating path of the electromotive drive 3, 4, 5.

According to the exemplary embodiment, the angle a is approximately 70°. In contrast, the entire actuating path of the electromotive drive 3, 4, 5 corresponds to a complete rotation of the drive pulley 4, i.e., according to the exemplary embodiment, to an angle of 360° of the drive pulley 4. According to the invention, the defined range α is reached by evaluating an electrical actuation signal of the electromotive drive, as shown in more detail in the exemplary embodiment of FIG. 3, or by evaluating signals from a sensor 7, as shown by way of example in FIG. 1 and also in the other exemplary embodiments.

Considering the embodiment variant according to FIG. 3, the electrical actuation signals of the electromotive drive 3, 4, 5 are evaluated at this point with regard to a current increase when the deflecting contour 4a is reached. In fact, when comparing the side view with the top view shown in FIG. 1, it can be seen that the deflecting contour 4a is equipped with a front and rear ramp, each of which merges into a plateau. As soon as the drive pulley 4 is rotated about its axis by means of the electric motor 3, the deflecting contour 4a ensures that the transmission lever 7 is increasingly pivoted counterclockwise about its axis when it hits the ramp, as indicated in FIG. 1. This causes the coupling element 6, which is connected to the transmission lever 7 in an articulated manner, or the coupling lever provided at this point, to move downwards and change from its “disengaged” position, which it assumes routinely and during normal operation, to the “engaged” position shown in FIG. 1. As a result, the emergency actuation lever chain 6, 7 also assumes its unlocked position. Now, the emergency operating lever chain 6, 7 can be actuated via the handle as a component of the emergency operating lever chain 6, 7 in order to open the locking mechanism 1, 2 manually and mechanically as described.

In order to ensure that the engaged position of the coupling element 6 and thus of the transmission lever 7 can be reliably detected and approached with the deflecting contour 4a in accordance with the functional position shown in FIG. 1, the exemplary embodiment shown in FIG. 3 evaluates the current increase I schematically indicated there as a function of the angle 0 swept over by the drive pulley 4. This is indicated by the schematic diagram. At this point, there is an increase in current when the drive pulley 4 moves with the deflecting contour 4a against the transmission lever 7 and lifts it against mechanical resistance and pivots it counterclockwise as described above in order to finally engage thee coupling element 6. This is indicated in FIG. 3, where the current increase can be identified first by a slope at the beginning of the deflecting contour 4a and then by a plateau region with an increased current increase.

In any case, this current increase, which is schematically indicated in FIG. 3, can be evaluated by a control unit 8 which controls the electromotive drive 3, 4, 5 and is only indicated, so that the electromotive drive 3, 4, 5 can be stopped when the so-called “parking position” shown in FIG. 1 is reached. This is again ensured by the control unit 8 acting on the electric motor 3.

Alternatively or additionally, the drive pulley 4 of the electromotive drive 3, 4, 5 and/or the electric motor 3 may also be assigned to the sensor 7 mentioned above. This sensor 7 is acted upon by means of a circumferential contour 9 on the drive pulley 4, as shown in FIGS. 1 and 2. In principle, the contour 9, as shown in FIG. 4, may also be a magnet provided on the drive pulley 4, which interacts with the sensor 7 designed as a Hall sensor when overlapping, so that the “parking position” already discussed can be easily detected and determined in this way. The variant according to FIG. 5 is equipped with a further embodiment type in which a sensor 7 is again realized in the form of a Hall sensor, which responds to rotational movements of a ring magnet on the output shaft of the electric motor 3 as a stop or contour 9 and then infers the position of the electric motor 3 and thus of the drive pulley 4.

This means that, according to the exemplary embodiment, the sensor 7 may operate in a tactile manner, as shown in FIGS. 1 and 2. In principle, contactless acting on the sensor 7 is also possible, as is illustrated in the case of the embodiment variant shown in FIGS. 4 and 5 with the Hall sensors provided there.

### LIST OF REFERENCE SIGNS

locking mechanism 1, 2
rotary latch 1
pawl 2
pin 2a
drive 3, 4, 5
electric motor 3
drive pulley 4
deflecting contour 4a
actuating cam 5
emergency actuation element 6, 7
coupling element 6
transmission lever 7
sensor 7
control unit 8
contour 9
current increase I

1. A motor vehicle lock, in particular motor vehicle door lock, with a locking mechanism substantially consisting of a rotary latch and a pawl, further with an electromotive drive for the locking mechanism, and with an emergency actuation element for manually opening of the locking mechanism, for example in the event of a failure of the electromotive drive,
wherein
the electromotive drive has a deflecting contour for unlocking the emergency actuation element.

2. The motor vehicle lock according to claim 1, wherein the deflecting contour sweeps over a defined range of an actuating path of the electromotive drive.

3. The motor vehicle lock according to claim 1, wherein the defined range is reached by evaluating an electrical actuation signal of the electromotive drive and/or signals from a sensor.

4. The motor vehicle lock according to claim 1, wherein the electrical actuation signal of the electromotive drive corresponds to a current increase when the deflecting contour is reached.

5. The motor vehicle lock according to claim 4, wherein the electromotive drive is switched off after the current increase has been detected.

6. The motor vehicle lock according to claim 1, wherein a sensor associated with a drive pulley of the electromotive drive and/or the electric motor is provided.

7. The motor vehicle lock according to claim 6, wherein a contour is assigned to the sensor.

8. The motor vehicle lock according to claim 1, wherein the sensor operates in a tactile or contactless manner.

9. The motor vehicle lock according to claim 1, wherein the sensor is designed as a switch, a Hall sensor, an optical sensor, or the like.

10. The motor vehicle lock according to claim 1, wherein the drive pulley has an actuating cam for the pawl.
